(19) United States
(12) Patent Application Publication
(10) Pub. No.: US 2026/0001994 A1
(43) Pub. Date: Jan. 1, 2026

(54) HIGH-MOLECULAR COMPOUND, MOLDING COMPOSITION, FILM AND CAPACITOR

(71) Applicant: Panasonic Intellectual Property Management Co., Ltd., Osaka (JP)

(72) Inventors: Yusuke OGIHARA, Osaka (JP); Takayuki HATTORI, Yamaguchi (JP); Tatsuya NAKAMURA, Osaka (JP)

(21) Appl. No.: 18/867,323

(22) PCT Filed: Jun. 13, 2023
(86) PCT No.: PCT/JP2023/021923

§ 371 Date: Nov. 19, 2024

(30) Foreign Application Priority Data
Jun. 21, 2022 (JP) 2022-099887

(51) Int. Cl. C08G 73/06; H01G 4/18

(52) U.S. Cl. CPC C08G 73/0633; H01G 4/18

(57) ABSTRACT

A high-molecular compound has a repeating unit (U) including a diazabenzene ring, a substituent directly bonded to the diazabenzene ring, and a carbonyl group. The substituent includes at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms.

### TECHNICAL FIELD

The present disclosure relates to high-molecular compounds, molding compositions, films, and capacitors and specifically relates to a novel high-molecular compound, a molding composition containing the high-molecular compound, a film including the high-molecular compound, and a capacitor including a dielectric layer including the high-molecular compound.

### BACKGROUND ART

Patent Literature 1 describes a film capacitor element. The film capacitor element is configured as a laminate in which at least a dielectric film layer as a poly-urea formaldehyde film and a metal evaporated film layer are stacked one on top of another.

Patent Literature 2 describes a film capacitor. The film capacitor includes a laminate film including a first electrode layer, a resin base member, a second electrode layer, and a dielectric layer, which are stacked one on top of another in this order. The dielectric layer includes a copolymer of vinylidene fluoride and tetrafluoroethylene.

In such a film capacitor as described in Patent Literature 1 and Patent Literature 2, increasing the capacitance without changing the type of a material used for the dielectric layer requires a reduction in thickness of the dielectric layer, but the processing difficulty in the reduction in thickness is considerable, and the reduction in thickness is more likely cause electric breakdown. Therefore, the dielectric constant of the material for the dielectric layer is required to be increased as compared with conventional film capacitors.

### CITATION LIST

### Patent Literature

Patent Literature 1: JP 2016-8323 A
Patent Literature 2: WO 2014/080832 A1

### SUMMARY OF INVENTION

It is an object of the present disclosure to provide a novel high-molecular compound with a high dielectric constant as compared with conventional high-molecular compounds, a molding composition containing the high-molecular compound, a film including the high-molecular compound, and a capacitor including a dielectric layer including the high-molecular compound.

A high-molecular compound according to an aspect of the present disclosure has a repeating unit (U) including a diazabenzene ring, a substituent directly bonded to the diazabenzene ring, and a carbonyl group, wherein the substituent includes at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms.

A molding composition according to another aspect of the present disclosure contains the high-molecular compound.

A film according to still another aspect of the present disclosure includes the high-molecular compound.

A capacitor according to yet another aspect of the present disclosure includes a pair of electrodes and a dielectric layer disposed between the pair of electrodes. The dielectric layer includes the high-molecular compound.

### BRIEF DESCRIPTION OF DRAWINGS

FIGS. 1A and 1B are each a schematic view of a capacitor according to the present embodiment.

### DESCRIPTION OF EMBODIMENTS

An exemplary embodiment of the present disclosure will now be described. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

### 1. Overview

Recently, as electric vehicles (EVs) and hybrid EVs have become increasingly popular, there has been growing demand for reducing the size of an inverter for use to control their motor. That is why demand for reducing the size of a capacitor, such as a film capacitor, as a component of the inverter has also been on the rise.

Reducing the thickness of a dielectric layer included in a capacitor is one of various methods for reducing the overall size of the capacitor while maintaining its performance. Nevertheless, reducing the thickness of the dielectric layer not only makes it rather difficult to pattern the dielectric layer into a desired shape but also increases the chances of causing dielectric breakdown as well.

The inventors carried out extensive research and development, not to reduce the thickness of the dielectric layer, but rather to find a material increasing the dielectric constant of the dielectric layer, in order to increase the capacitance of the capacitor and reduce the size of the capacitor while suppressing the electric breakdown of the dielectric layer from being caused. As a result, the inventors found a novel high-molecular compound which exhibits a dielectric constant higher than the dielectric constant (falling within the range from about 2.0 to about 3.0) of the conventional high-molecular compound, for example, exhibits a dielectric constant of higher than or equal to 3.5.

A high-molecular compound (hereinafter also referred to as a high-molecular compound (P)) according to the present embodiment has a repeating unit (U) including a diazabenzene ring (hereinafter also referred to as a diazabenzene ring (K)), a substituent (hereinafter also referred to as a substituent(S)) directly bonded to the diazabenzene ring (K), and a carbonyl group. The substituent(S) includes at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms.

That is, the high-molecular compound (P) is a high-molecular compound having the repeating unit (U) including one diazabenzene ring (K) to which the substituent(S) is directly bonded and one carbonyl group.

The present embodiment provides: the novel high-molecular compound (P) with a higher dielectric constant than conventional high-molecular compounds: a molding composition (hereinafter also referred to as a composition (Q)) containing the high-molecular compound (P): a film (hereinafter also referred to as a film (R)) including the high-molecular compound (P); and a capacitor (hereinafter also referred to as a capacitor (G)) including a dielectric layer including the high-molecular compound (P). Thus, the high-molecular compound (P) according to the present embodiment is a dielectric compound with a high dielectric constant. Note that the application of the high-molecular compound (P) is not limited to the production of the dielectric layer in the capacitor, but the high-molecular compound (P) may be used in various applications.

As described above, the present disclosure provides the novel high-molecular compound with a higher dielectric constant than conventional high-molecular compounds, the molding composition containing the high-molecular compound, the film including the high-molecular compound, and the capacitor including the dielectric layer including the high-molecular compound.

### 2. Details

### <High-Molecular Compound>

The high-molecular compound (P) has the repeating unit (U). The “high-molecular compound” means a compound having at least two, preferably four or more, more preferably five or more, monomeric units. The “repeating unit” means two or more monomeric units included in the high-molecular compound (P). The high-molecular compound (P) may have one type of repeating unit (U), or two or more types of repeating units (U). The high-molecular compound (P) may have another repeating unit (W), other than the repeating unit (U).

The repeating unit (U) includes the diazabenzene ring (K), the substituent(S) directly bonded to the diazabenzene ring (K), and the carbonyl group.

The “diazabenzene ring” is a benzene ring in which two of the aromatic ring carbon atoms have been replaced with nitrogen atoms. Examples of the diazabenzene ring (K) include a pyridazine ring (1,4-diazabenzene ring), a pyrimidine ring (1,3-diazabenzene ring), and a pyrazine ring (1,4-diazabenzene ring).

The repeating unit (U) includes the substituent(S) directly bonded to the diazabenzene ring (K). Here, “directly bonded” means that the substituent(S) is bonded directly to a heteroaromatic ring carbon atom of the diazabenzene ring (K), that is, without any other atom between the substituent(S) and the heteroaromatic ring carbon atom. The substituent(S) is bonded to one or both of two carbon atoms other than carbon atoms bonded to adjacent repeating units in the diazabenzene ring (K) in the repeating unit (U). The carbonyl group is a group expressed by —C(═O)—.

The substituent(S) includes at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms. The substituent(S) is referred to as a “substituent” also when the substituent(S) is the hydrogen atom.

Examples of the halogen atom include a fluorine atom, a chlorine atom, a bromine atom, and an iodine atom. Among these atoms, in terms of an improvement in the dielectric constant, at least one selected from the group consisting of the fluorine atom, the chlorine atom, and the bromine atom is preferable.

The hydroxy group is a group expressed by —OH. The formyl group is a group expressed by —CHO. The carboxy group is a group expressed by —COOH.

Examples of the alkyl group having 1 to 6 carbon atoms include a methyl group, an ethyl group, a propyl group, an isopropyl group, an n-butyl group, an isobutyl group, a sec-butyl group, a t-butyl group, an n-pentyl group, and an n-hexyl group. Among these groups, in terms of an improvement in the dielectric constant, an alkyl group having 1 to 4 carbon atoms is preferable, an alkyl group having 1 to 3 carbon atoms is more preferable, and at least one selected from the group consisting of a methyl group and an ethyl group is preferable.

Examples of the haloalkyl group having 1 to 6 carbon atoms include a group obtained by replacing some or all of hydrogen atoms of the alkyl group having 1 to 6 carbon atoms with halogen atoms. Among these groups, in terms of an improvement in the dielectric constant, a group obtained by replacing some or all of hydrogen atoms of the alkyl group having 1 to 4 carbon atoms with at least one type of atoms selected from the group consisting of fluorine atoms, chlorine atoms, and bromine atoms is preferable, a group obtained by replacing 1 to 3 hydrogen atoms of an alkyl group having 1 or 2 carbon atoms with fluorine atoms, chlorine atoms, or bromine atoms is more preferable, a group obtained by replacing 1 to 3 hydrogen atoms of the methyl group with fluorine atoms, chlorine atoms, or bromine atoms is much more preferable, and at least one selected from the group consisting of a fluoromethyl group, a difluoromethyl group, a trifluoromethyl group, a chloromethyl group, a dichloromethyl group, a trichloromethyl group, a bromo methyl group, a dibromo methyl group, and a tribromo methyl group is particularly preferable.

Examples of the hydroxy alkyl group having 1 to 6 carbon atoms include a group obtained by replacing some or all of hydrogen atoms of the alkyl group having 1 to 6 carbon atoms with hydroxy groups. Among these groups, in terms of an improvement in the dielectric constant, a group obtained by replacing some or all of hydrogen atoms of the alkyl group having 1 to 4 carbon atoms with hydroxy groups is preferable, a group obtained by replacing 1 to 3 hydrogen atoms of the alkyl group having 1 to 3 carbon atoms with hydroxy groups is more preferable, a group obtained by replacing 1 or 2 hydrogen atoms of the alkyl group having 1 or 2 carbon atoms with hydroxy groups is much more preferable, and a 1,2-dihydroxy ethyl group is particularly preferable.

As the substituent(S), at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms is preferably included, and at least one selected from the group consisting of a hydrogen atom, a fluorine atom, a chlorine atom, a bromine atom, a hydroxy group, a formyl group, a carboxy group, a methyl group, an ethyl group, a monohalomethyl group, a dihalomethyl group, a trihalomethyl group, and a dihydroxy ethyl group is more preferably included.

The repeating unit (U) preferably includes at least one selected from the group consisting of a repeating unit (A) expressed by the following formula (1), a repeating unit (B) expressed by the following formula (2), a repeating unit (C) expressed by the following formula (3), a repeating unit (D) expressed by the following formula (4), and a repeating unit (E) expressed by the following formula (5). In this case, the dielectric constant of the high-molecular compound (P) can be further increased.

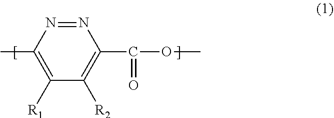

In the formula (1), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

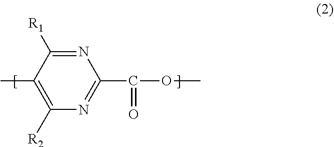

In the formula (2), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

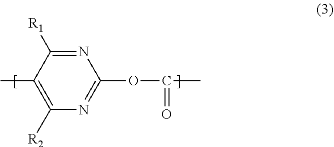

In the formula (3), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

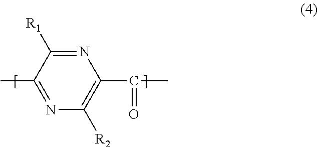

In the formula (4), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

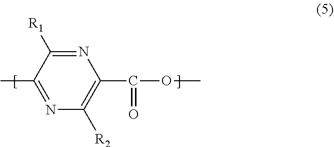

In the formula (5), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

Examples of the high-molecular compound (P) include a high-molecular compound (I) having the repeating unit (A), a high-molecular compound (II) having a repeating unit (B), a high-molecular compound (III) having the repeating unit (C), a high-molecular compound (IV) having the repeating unit (D), and a high-molecular compound (V) having the repeating unit (E). [High-Molecular Compound (I)]

The high-molecular compound (I) is a high-molecular compound having the repeating unit (A).

In the formula (1) of the repeating unit (A), it is preferable that one of R₁ and R₂ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either the same as the one or H, and it is more preferable that R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is H. Selecting R₁ and R₂ as described above enables a high-molecular compound (I) with a further increased dielectric constant to be synthesized by a further simplified method.

### [High-Molecular Compound (II)]

The high-molecular compound (II) is a high-molecular compound having the repeating unit (B).

In the formula (2) of the repeating unit (B), it is preferable that one of R₁ and R₂ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either the same as the one or H, and it is more preferable that R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is H. Selecting R₁ and R₂ as described above enables a high-molecular compound (II) with a further increased dielectric constant to be synthesized by a further simplified method.

### [High-Molecular Compound (III)]

The high-molecular compound (III) is a high-molecular compound having the repeating unit (C).

In the formula (3) of the repeating unit (C), it is preferable that R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either the same as R₁ or H, and it is more preferable that R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is H. Selecting R₁ and R₂ as described above enables a high-molecular compound (III) with a further increased dielectric constant to be synthesized by a further simplified method.

### [High-Molecular Compound (IV)]

The high-molecular compound (IV) is a high-molecular compound having the repeating unit (D).

In the formula (4) of the repeating unit (D), it is preferable that R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either the same as R₁ or H, and it is more preferable that R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is H. Selecting R₁ and R₂ as described above enables a high-molecular compound (IV) with a further increased dielectric constant to be synthesized by a further simplified method.

### [High-Molecular Compound (V)]

The high-molecular compound (V) is a high-molecular compound having the repeating unit (E).

In the formula (5) of the repeating unit (E), it is preferable that one of R₁ and R₂ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either the same as the one or H, and it is more preferable that R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is H. Selecting R₁ and R₂ as described above enables a high-molecular compound (V) with a further increased dielectric constant to be synthesized by a further simplified method.

The molecular weight of the high-molecular compound (P) is, for example, greater than or equal to 2.0×10² and less than or equal to 1×10⁸, preferably greater than or equal to 5.0×10² and less than or equal to 2×10⁷, and more preferably greater than or equal to 1×10³ and less than or equal to 1×10⁷. In this case, the moldability of the high-molecular compound (P) can be further improved.

The dielectric constant of the high-molecular compound (P) is, for example, greater than or equal to 3.0, preferably greater than or equal to 3.5, more preferably greater than or equal to 4.0, much more preferably greater than or equal to 4.5, and particularly preferably greater than or equal to 5.0. The upper limit of the dielectric constant of the high-molecular compound (P) is not limited to any particular value but may be, for example, less than or equal to 7.0.

### <Method of Synthesizing High-Molecular Compound>

The high-molecular compound (P) can be synthesized by, for example, the following synthesis method.

### [Method of Synthesizing High-Molecular Compounds (I) to (III) and (V)]

The high-molecular compounds (I) to (III) and (V) can each be obtained as a polycondensate expressed by the following formula (p1) by: synthesizing a monomer compound (hereinafter also referred to as a monomer compound (MA)) expressed by, for example, the following formula (ma); and causing a polycondensation reaction of the monomer compound (MA) as shown by the following formula (r1).

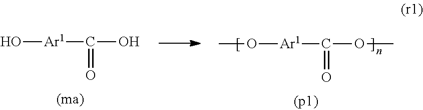

In the formulae (ma) and (p1), Ar¹ is a group obtained by removing two hydrogen atoms bonded to the carbon atoms from diazabenzene to which an R₁ group and an R₂ group are directly bonded, and n is an integer greater than or equal to 2.

### (Monomer Compound)

Examples of the monomer compound (MA) include a monomer compound (MA1) expressed by the following formula (i) which gives the high-molecular compound (I), a monomer compound (MA2) expressed by the following formula (ii) which gives the high-molecular compound (II), a monomer compound (MA3) expressed by the following formula (iii) which gives the high-molecular compound (III), and a monomer compound (MA5) expressed by the following formula (v) which gives the high-molecular compound (V).

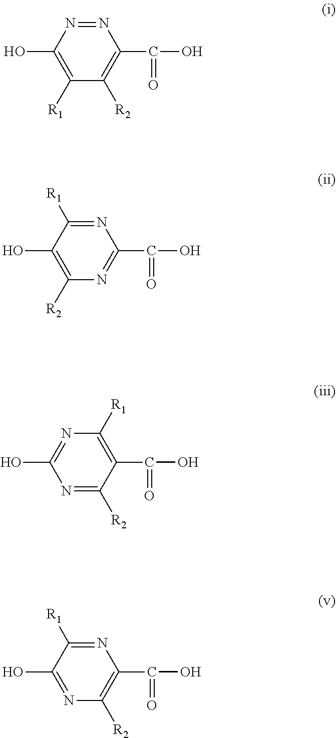

In each of the formulae (i) to (iii) and (v), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

### (Polycondensation Reaction)

The polycondensation reaction, expressed by the formula (r1), of the monomer compound (MA) can be caused in accordance with a normal polycondensation procedure of a hydroxycarboxylic acid. Examples of a method for causing such a polycondensation reaction include a method including: mixing the monomer compound (MA) and concentrated sulfuric acid as an esterification catalyst and a dehydrating agent with each other to obtain a mixture; and heating the mixture, for example, to a temperature higher than or equal to 60° C. and lower than or equal to 140° C., preferably higher than or equal to 60° C. and lower than or equal to 100° C. Classifying the mixture, which is a product of the polycondensation reaction, provides a desired polymer dielectric.

When in the monomer compound (MA), R₁ and/or R₂ is OH or a hydroxy group-containing group such as CHOHCH₂OH, the polycondensation reaction is performed by employing a monomer compound (MA) which is obtained by allowing acetyl chloride (CH₃COCl) to react with the monomer compound (MA) to protect the hydroxy group(s) by conversion into an acetoxy group(s) (—OCOCH₃). After the polycondensation reaction, sodium hydroxide (a hydrous ethanol solvent) is allowed to react with the polycondensate thus obtained to cause hydrolysis (deprotection), thereby obtaining the high-molecular compound (P).

Moreover, when R₁ and/or R₂ is COOH, the polycondensation reaction is performed by employing a monomer compound (MA) which is obtained by allowing methanol to react with the monomer compound (MA) in the presence of thionyl chloride (SOCl₂) to protect the COOH by conversion into a methoxy carbonyl group (COOCH₃). After the polycondensation reaction, sodium hydroxide (a hydrous ethanol solvent) is allowed to react with the polycondensate thus obtained to cause hydrolysis (deprotection), thereby obtaining the high-molecular compound (P).

### (Method of Synthesizing Monomer Compound)

The monomer compound (MA) can be synthesized by: employing a compound (hereinafter also referred to as a reaction start substance (NA)) which is expressed by any one of the formulae (i) to (iii) and (v) and in which R₁ and R₂ are each a hydrogen atom (H); and allowing the reaction of converting R₁ and/or R₂ from the hydrogen atom into the substituent(S) by a procedure described below. In each of reaction stages during the synthesis of the monomer compound (MA), a reaction also occurs at a position(s) other than a desired position in the compound, thereby producing by-products such as products different in replacement position and polysubstituted products, and therefore, these by-products are classified by, for example, column chromatographic separation to isolate a desired product.

(Conversion Method into Substituent)

In the reaction start substance (NA) and a compound obtained from the reaction start substance (NA) by conversion, the following reactions can convert the hydrogen atoms into the respective substituents(S).
H→Cl: Cl₂ is allowed to react with the reaction start substance (NA) (product (T1)).
H→Br: Br₂ is allowed to react with the reaction start substance (NA).
H→F: KF is allowed to react with the reaction start substance (NA) (reaction solvent: e.g., sulfolane).
H→OH: A sodium hydroxide aqueous solution is allowed to react with the product (T1).
H→CH₃: Methyl chloride (CH₃Cl) is allowed to react with the reaction start substance (NA) in the presence of aluminum chloride (AlCl₃) (product (T2)).
H→C₂H₅: Ethyl lithium (C₂H₅Li) (a toluene solvent) is allowed to react with the reaction start substance (NA) (product (T3)).
H→CH₂F: F₂ is allowed to react with the product (T2) (product (T4)).
H→CHF₂: F₂ is allowed to react with the product (T4) (product (T5)).
H→CF₃: F₂ is allowed to react with the product (T5).
H→CH₂Cl: Cl₂ is allowed to react with the product (T2) (product (T6)).
H→CHCl₂: Cl₂ is allowed to react with the product (T6) (product (T7)).
H→CCl₃: Cl₂ is allowed to react with the product (T7).
H→CH₂Br: Br₂ is allowed to react with the product (T2) (product (T8)).
H→CHBr₂: Br₂ is allowed to react with the product (T8) (product (T9)).
H→CBr₃: Br₂ is allowed to react with the product (T9).
H→CHO: A sodium hydroxide aqueous solution is allowed to react with the product (T6) to convert the chloromethyl group into a hydroxy methyl group, thereby obtaining a hydroxy methyl group-containing compound (product (T10)), and pyridinium chlorochromate (PCC) (a dichloromethane solvent) is allowed to react with the product (T10).
H→COOH: A potassium dichromate (K₂Cr₂O₇)/sulfuric acid aqueous solution is allowed to react with the product (T10).
H→CHOHCH₂OH: Cl₂ is allowed to react with the product (T3) to convert the ethyl group into a 1,2-dichloroethyl group to obtain a compound, and a sodium hydroxide aqueous solution is allowed to react with the compound.

Using such a “Conversion Method into Substituent” enables a monomer compound (MA) with, for example, R₁ converted from the hydrogen atom into any one of the substituents(S) to be synthesized. Moreover, a similar method enables a monomer compound (MA) with, for example, both R₁ and R₂ each converted from the hydrogen atoms into any one of the substituents(S) to be synthesized.

### [Method of Synthesizing High-Molecular Compound (IV)]

The high-molecular compound (IV) can be obtained as a polycondensate expressed by the following formula (p2) by: synthesizing a monomer compound (hereinafter also referred to as a monomer compound (MB1)) expressed by, for example, the following formula (mb1) and a monomer compound (hereinafter also referred to as a monomer compound (MB2)) expressed by the following formula (mb2); and allowing a polycondensation reaction between the monomer compound (MB1) and the monomer compound (MB2) as shown by the following formula (r2).

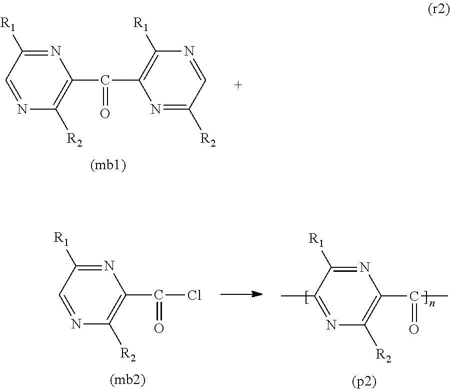

In each of the formula (mb1) and (mb2), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

### (Polymerization Reaction)

The polymerization reaction of the formula (r2) can be performed in the presence of aluminum trichloride (AlCl₃) in accordance with a procedure of a normal Friedel-Crafts acylation. Examples of a method for performing such a polymerization reaction include the following method. First of all, the monomer compound (MB1) is dissolved in a solvent such as dichloromethane and is then cooled. The cooling temperature at this time is preferably lower than or equal to 0° C. Then, aluminum trichloride (AlCl₃) is added to a solution thus obtained of the monomer compound (MB1) and is stirred. The solution in which the monomer compound (MB1) has been dissolved and the aluminum trichloride (AlCl₃) has been diffused is defined as (solution 1). Moreover, the monomer compound (MB2) is separately dissolved in a solvent the same as the solvent in which the monomer compound (MB1) has been dissolved, thereby obtaining a solution, and the solution is then cooled. The cooling temperature at this time is preferably lower than or equal to 0° C. The solution, in which the monomer compound (MB2) has been dissolved, is defined as (solution 2). Then, the (solution 1) and the (solution 2) are mixed with each other and are stirred. This promotes the polymerization reaction, thereby providing a high-molecular compound. To promote the polymerization reaction, a temperature rise is employed while the solutions are stirred. The temperature after the temperature rise at this time is desirably about a room temperature, and particularly desirably higher than or equal to 25° C. and lower than or equal to 30° C.

### (Method of Synthesizing Monomer Compound)

The monomer compound (MB1) can be synthesized in the following manner. A compound (2-carboxy pyrazine, hereinafter also referred to as a reaction start substance (NB1)) which is expressed by the following formula (mc1) and in which R₁ and R₂ are each a hydrogen atom (H) and a compound (pyrazine, hereinafter also referred to as a reaction start substance (NB2)) which is expressed by the following formula (mc2) and in which R₁ and R₂ are each a hydrogen atom (H) are prepared. Then, for the reaction start substance (NB1), R₁ is converted into any one of the substituents(S) by the procedure described in “Conversion Method into Substituent”, thereby obtaining a compound (NC1) in which R₁ has been converted into any one of the substituents (S). Moreover, for the reaction start substance (NB2), a similar conversion reaction is allowed to obtain a compound (NC2) in which R₁ has been converted into any one of the substituents (S). Then, phosphorus pentachloride (PCl₅) is allowed to react with the compound (NC1) thus obtained, thereby obtaining a monomer compound (MB2) which is oxychloride expressed by the formula (mb2). Moreover, the monomer compound (MB2) and the compound (NC2) thus obtained are subjected to the Friedel-Crafts acylation in the presence of aluminum trichloride (AlCl₃), thereby obtaining the monomer compound (MB1).

In each reaction stage in the synthesis of the monomer compound (MB1) and the monomer compound (MB2), a reaction also occurs at a position(s) other than a desired position in the compound, thereby producing by-products such as products different in replacement position and polysubstituted products, and therefore, these by-products are classified by, for example, column chromatographic separation to isolate a desired product.

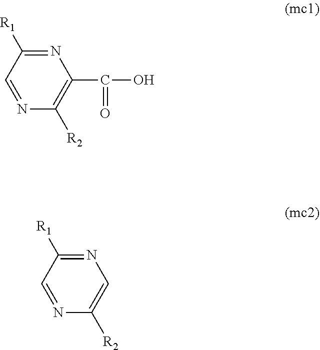

Moreover, a similar method enables a monomer compound (MB1) and a monomer compound (MB2) in which, for example, both R₁ and R² each have been converted from a hydrogen atom into any one of the substituents(S) can be synthesized.

### <Molding Composition>

The molding composition (hereinafter also referred to as the composition (Q)) according to the present embodiment contains the high-molecular compound (P). The composition (Q) can be appropriately used to produce a molded product such as a film. The composition (Q) can provide a molded product of a high-molecular compound with a higher dielectric constant than conventional high-molecular compounds.

The composition (Q) may contain, for example, a plasticizer, an additive such as a filler, an organic solvent, and a solvent such as water, in addition to the high-molecular compound (P).

The proportion of the high-molecular compound (P) in the composition (Q) is preferably greater than or equal to 90% by mass, more preferably greater than or equal to 95% by mass, and much more preferably greater than or equal to 98% by mass. The proportion is, for example, less than or equal to 100% by mass, and preferably less than or equal to 99.5% by mass.

### <Film>

The film (hereinafter also referred to as the film (R)) according to the present embodiment includes the high-molecular compound (P). The film (R) can exhibit a high dielectric constant and can appropriately be used as a dielectric layer of, for example, the capacitor (G). The film (R) can provide a film with a higher dielectric constant than conventional films.

The film (R) may be produced from, for example, the high-molecular compound (P) or the molding composition (Q) containing the high-molecular compound (P). Examples of a method for producing such a film (R) are the following methods. First of all, the high-molecular compound (P), the molding composition (Q), or the like is loaded into an extruder and is melted. The melting temperature at this time is, for example, higher than or equal to 180° C. and lower than or equal to 270° C. Next, the high-molecular compound (P), the molding composition (Q), or the like thus melted is formed into a rectangular sheet while cooled by a cooling roll of a cast molding machine. Then, the rectangular sheet thus obtained is stretched by using a longitudinal stretching device in the direction in which the film moves and is then stretched by using a traverse stretching device in a film width direction. Thus, the film (R) is obtained.

### <Capacitor>

The capacitor (hereinafter also referred to as the capacitor (G)) according to the present embodiment includes a pair of electrodes 11 and a dielectric layer 21 disposed between the pair of electrodes 11. The dielectric layer 21 includes the high-molecular compound (P).

As the dielectric layer 21, for example, a film produced from the high-molecular compound (P) is usually used.

Examples of the capacitor (G) include a wound capacitor and a stacked capacitor. The wound capacitor includes a wound body 41 having a structure including a pair of electrodes 11 and a dielectric layer 21 disposed between the pair of electrodes 11. The stacked capacitor includes a laminate having a structure including a pair of electrodes 11 and a dielectric layer 21 disposed between the pair of electrodes 11.

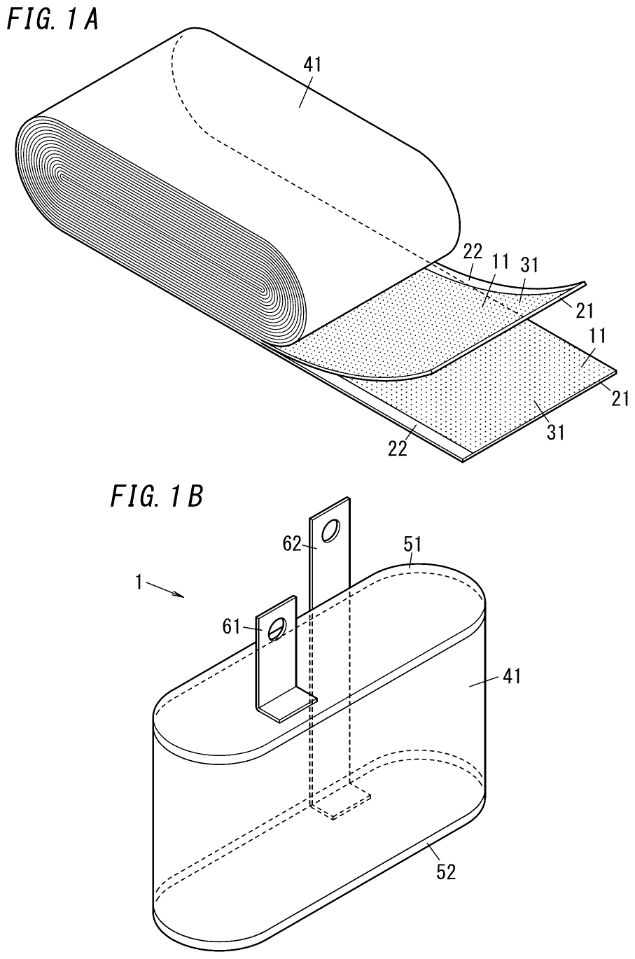

An example of the wound capacitor according to the present embodiment is shown in FIG. 1. FIG. 1A is an example of the wound body 41 included in the wound capacitor. The wound body 41 may be formed, for example, by: forming an electrode 11 such as an electrode layer on a surface of the dielectric layer 21 to produce a metallized film 31, and stacking, usually, a pair of such metallized films 31 one on top of another and winding up the metallized films 31. FIG. 1B is an example of a capacitor 1 including the wound body 41.

The wound capacitor according to the present embodiment may be produced in the following manner. First of all, a film including the high-molecular compound (P) is formed as the dielectric layer 21. On a surface of the dielectric layer 21, an electrode layer including aluminum, zinc, magnesium, etc. is formed as the electrode 11 by, for example, an evaporation process or a sputtering process, thereby forming the metallized film 31. In this case, the metallized film 31 includes a margin portion 22 where the electrode 11 is not formed. The margin portion 22 is provided along one of long sides of the metallized film 31. Next, a pair of such metallized films 31 are normally laid one on top of another such that the long sides of the metallized films 31 are aligned with each other, the metallized films 31 are wound up such that the long side with the margin portion 22 of one of the metallized films 31 is located opposite from the long side with the margin portion 22 of the other of the metallized films 31 and that the electrodes 11 faces each other with the dielectric layer 21 disposed between the electrodes 11 themselves. A circular cylindrical wound body is formed by winding up the pair of metallized films 31 that are laid one on top of the other. Then, the circular cylindrical wound body is pressed on both side surfaces thereof, thereby obtaining a wound body 41 having an oval cross section.

Then, external electrodes 51 and 52 are formed on both respective ends of the wound body 41 by metallikon (metal spraying), thereby obtaining the capacitor 1 which is a wound capacitor. The external electrodes 51 and 52 may be made of, for example, aluminum, zinc, magnesium, or an alloy thereof. The external electrodes 51 and 52 are electrically connected to the pair of electrodes 11, respectively, and the pair of electrodes 11 serve as a pair of internal electrodes.

Moreover, the external electrodes 51 and 52 are electrically connected to external connection terminals 61 and 62, respectively, by solder welding, resistor welding, ultrasonic wave welding, laser welding, or the like, thereby producing the capacitor 1 of FIG. 1B.

The capacitance of the capacitor (G) is, for example, greater than or equal to 8.0×10² μF, preferably greater than or equal to 1.0×10³ μF, more preferably greater than or equal to 1.2× 10³ μF, and much more preferably greater than or equal to 1.4×10³ μF. The upper limit of the capacitance of the capacitor (G) is not limited to a particular value but is, for example, less than or equal to 2.0×10³ μF.

Thus, the capacitor (G) enables the capacitance of the capacitor 1 to be increased while the thickness of the dielectric layer 21 is maintained. Moreover, the size of the capacitor 1 can be reduced while the capacitance of the capacitor 1 is maintained.

### EXAMPLES

The present disclosure will be described in further detail below with reference to examples. The present disclosure is, however, not limited to these examples.

### <Synthesis of High-Molecular Compound>

### [Synthesis of Monomer Compound]

### (Reaction Start Substance)

Reaction start substances employed in the synthesis of monomer compounds for forming respective repeating units described below are shown below.
Repeating unit (A): 6-hydroxy pyridazine-3-carboxylic acid (CSC000183102 manufactured by Chemspace)
Repeating unit (B): 5-hydroxy pyrimidine-2-carboxylic acid (CSC020625580 manufactured by Chemspace)
Repeating unit (C): 2-hydroxy pyrimidine-5-carboxylic acid (CSC011934652 manufactured by Chemspace)
Repeating unit (D):
   Pyrazine (CSC011215633 manufactured by Chemspace)
   Pyrazine-2-carboxylic acid (CSC000210692 manufactured by Chemspace)
Repeating unit (E): 5-hydroxy pyrazine-2-carboxylic acid (CSC000736506 manufactured by Chemspace)

### (Synthesis of Monomer Compound)

By the method described in the specification, monomer compounds including substituents (R₁ and R₂) shown in the examples (high-molecular compound (I): Examples 1 to 54, high-molecular compound (II): Examples 55 to 90, high-molecular compound (III): Examples 91 to 127, high-molecular compound (IV): Examples 128 to 164, high-molecular compound (V): Examples 165 to 219) in Tables 1 to 10 were synthesized.

### [Synthesis of High-Molecular Compound]

### (Synthesis of High-Molecular Compounds (I) to (III) and (V))

A polycondensation reaction of the monomer compounds thus synthesized was caused by the following procedure, and thereby, the high-molecular compounds (I) to (III) and (V) were synthesized. The monomer compound (MA) thus synthesized and concentrated sulfuric acid were mixed with each other and were heated to a temperature higher than or equal to 60° C. and lower than or equal to 100° C., thereby causing the polycondensation reaction, thereby obtaining a product of the polycondensation reaction as a mixture. The mixture was classified, thereby obtaining a desired high-molecular compound. The high-molecular compound thus obtained was washed with acetone (item number 013-00356 manufactured by FUJIFILM Wako Pure Chemical Corporation) and was dried at 70° C.

### (Synthesis of High-Molecular Compound (IV))

A polymerization reaction of the monomer compounds thus synthesized was caused by the following procedure, and thereby, the high-molecular compound (IV) was synthesized. The monomer compound (MB1) thus synthesized was dissolved in dichloromethane and was cooled to 0° C. or lower. Aluminum trichloride (AlCl₃) was added to a solution thus obtained of the monomer compound (MB1) and was stirred, thereby obtaining (solution 3). Next, the monomer compound (MB2) was dissolved in dichloromethane, and was cooled to 0° C. or lower, thereby obtaining (solution 4). While the (solution 3) and the (solution 4) thus obtained were mixed with each other and were stirred, the temperature was increased to higher than or equal to 25° C. and lower than or equal to 30° C. to cause the polymerization reaction, thereby obtaining a high-molecular compound. The high-molecular compound thus obtained was washed with acetone (019-00356 manufactured by FUJIFILM Wako Pure Chemical Corporation) and was dried at 60° C.

### <Production of Capacitor>

The high-molecular compound (P) thus synthesized was employed to form a film (dielectric layer) in the following manner, and the film (the dielectric layer) was employed to produce a wound capacitor (the area of the dielectric layer: 90 m², the thickness of the dielectric layer: 3 μm). First of all, the high-molecular compound (P) thus synthesized was loaded into an extruder and was melted at a melting temperature of higher than or equal to 180° C. and lower than or equal to 270° C. Then, the high-molecular compound (P) thus melted was cooled by a cooling roll of a cast molding machine, thereby forming a rectangular sheet. Then, the rectangular sheet was stretched by using a longitudinal stretching device in the direction in which the film moves, the sheet was subsequently stretched by using a traverse stretching device in a film width direction and was then cut to the area of the dielectric layer, thereby obtaining the film (the dielectric layer). The film (the dielectric layer) was employed to produce a wound capacitor.

### <Evaluation>

The molecular weight of the high-molecular compound (P) thus synthesized and the capacitance of the capacitor (G) thus produced were measured by the method described below, and the dielectric constant of the high-molecular compound (P) was calculated.

### (Molecular Weight)

The range of the molecular weight of the high-molecular compound (P) thus synthesized was measured by gel permeation chromatography (GPC) (standard polystyrene conversion).
GPC measurement device: Shodex GPC-104 manufactured by Showa Denko K.K.
GPC column: Shodex KF-405LHQ manufactured by Showa Denko K.K.
Eluent: Chloroform (item number 038-02606 manufactured by FUJIFILM Wako Pure Chemical Corporation)
Flow rate: 0.2 mL/min
Column temperature: 40° C.
Detector: Differential refractive index (RI) detector
Standard substance: Polystyrene

### (Capacitance)

The capacitance of the capacitor thus produced was measured by using an LCR meter (IM3536 manufactured by HIOKI E.E. CORPORATION) at a frequency of 1 kHz and a voltage of 450 V (unit: μF).

### (Dielectric Constant)

The dielectric constant (ε) of the high-molecular compound (P) thus obtained was calculated from the value (C(μF)) of the capacitance of the capacitor thus measured, the area of the dielectric layer, and the thickness of the dielectric layer.

For the high-molecular compounds (I) to (V) synthesized in the examples, the types of the substituents R₁ and R₂, the molecular weight, the dielectric constant, and the value of the capacitance (μF) of the capacitor are shown in Tables 1 to 10 below.

TABLE 1

| | | Substituent | | | | Capacitance |
|---|---|---|---|---|---|---|
| | High-Molecular Compound (I) | R₁ | R₂ | Molecular Weight | Dielectric Constant | (μF) |
| Example 1 Example 2 Example 3 Example 4 Example 5 Example 6 Example 7 | 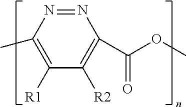 | F H F Cl H Cl Br | H F F H Cl Cl H | 7.3 × 10²-3.3 × 10⁶ 7.3 × 10²-3.3 × 10⁶ 8.7 × 10²-3.7 × 10⁶ 8.1 × 10²-3.7 × 10⁶ 8.1 × 10²-3.7 × 10⁶ 9.9 × 10²-4.5 × 10⁶ 1.0 × 10⁵-4.7 × 10⁶ | 4.3 4.3 4.2 4.4 4.4 4.4 4.5 | 1.2 × 10³ 1.2 × 10³ 1.2 × 10³ 1.2 × 10³ 1.2 × 10³ 1.2 × 10³ 1.2 × 10³ |
| Example 8 | | H | Br | 8.9 × 10 [symbol] -4.0 × 10⁶ | 4.5 | 1.2 × 10³ |
| Example 9 | | Br | Br | 1.5 × 10³-6.6 × 10⁶ | 4.5 | 1.2 × 10³ |
| Example 10 | | OH | H | 7.2 × 10⁷-3.2 × 10⁶ | 5.2 | 1.4 × 10³ |
| Example 11 | | H | OH | 7.2 × 10⁷-3.2 × 10⁶ | 5.2 | 1.4 × 10³ |
| Example 12 | | OH | OH | 8.0 × 10²-3.6 × 10⁶ | 5.8 | 1.6 × 10³ |
| Example 13 | | CHO | H | 7.8 × 10²-3.5 × 10⁶ | 4.8 | 1.3 × 10³ |
| Example 14 | | H | CHO | 7.8 × 10²-3.5 × 10⁶ | 4.8 | 1.3 × 10³ |
| Example 15 | | CHO | CHO | 9.3 × 10²-4.2 × 10⁶ | 5.0 | 1.3 × 10³ |
| Example 16 | | COOH | H | 8.6 × 10²-3.9 × 10⁶ | 4.8 | 1.3 × 10³ |
| Example 17 | | H | COOH | 8.6 × 10²-3.9 × 10⁶ | 4.8 | 1.3 × 10³ |
| Example 18 | | COOH | COOH | 1.1 × 10³-4.9 × 10⁶ | 4.9 | 1.4 × 10³ |
| Example 19 | | CH₃ | H | 7.1 × 10²-3.2 × 10⁶ | 4.2 | 1.1 × 10³ |
| Example 20 | | H | CH₃ | 7.1 × 10²-3.2 × 10⁶ | 4.2 | 1.1 × 10³ |
| Example 21 | | CH₃ | CH₃ | 7.8 × 10²-3.5 × 10⁶ | 3.9 | 1.1 × 10³ |
| Example 22 | | C₂H₅ | H | 7.8 × 10²-3.5 × 10⁶ | 3.9 | 1.1 × 10³ |
| Example 23 | | H | C₂H₅ | 7.8 × 10²-3.5 × 10⁶ | 3.9 | 1.1 × 10³ |
| Example 24 | | C₂H₅ | C₂H₅ | 9.3 × 10²-4.2 × 10⁶ | 3.5 | 1.0 × 10³ |
| Example 25 | | CH₂F | H | 8.0 × 10²-3.6 × 10⁶ | 4.1 | 1.1 × 10³ |
| Example 26 | | H | CH₂F | 8.0 × 10²-3.6 × 10⁶ | 4.1 | 1.1 × 10³ |
| Example 27 | | CH₂F | CH₂F | 9.7 × 10²-4.4 × 10⁶ | 3.8 | 1.1 × 10³ |

[symbol]

indicates data missing or illegible when filed

TABLE 2

| | | Substituent | | | | Capacitance |
|---|---|---|---|---|---|---|
| | High-Molecular Compound (I) | R₁ | R₂ | Molecular Weight | Dielectric Constant | (μF) |
| Example 28 Example 29 Example 30 Example 31 Example 32 Example 33 Example 34 | 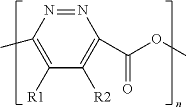 | CHF₂ H CHF₂ CF₃ H CF₃ CH₂Cl | H CHF₂ CHF₂ H CF₃ CF₃ H | 9.0 × 10²-4.0 × 10⁶ 9.0 × 10²-4.0 × 10⁶ 1.2 × 10³-5.2 × 10⁶ 9.9 × 10²-4.5 × 10⁶ 9.9 × 10²-4.5 × 10⁶ 1.3 × 10³-6.0 × 10⁶ 8.9 × 10²-4.0 × 10⁶ | 4.0 4.0 3.5 3.8 3.8 3.5 4.1 | 1.1 × 10³ 1.1 × 10³ 1.1 × 10³ 1.1 × 10³ 1.1 × 10³ 1.0 × 10³ 1.1 × 10³ |
| Example 35 | | H | CH₂Cl | 8.9 × 10²-3.3 × 10⁶ | 4.1 | 1.1 × 10³ |
| Example 36 | | CH₂Cl | CH₂Cl | 1.1 × 10³-3.3 × 10⁶ | 3.9 | 1.1 × 10³ |
| Example 37 | | CHCl₂ | H | 1.1 × 10³-3.3 × 10⁶ | 4.1 | 1.1 × 10³ |
| Example 38 | | H | CHCl₂ | 1.1 × 10³-3.3 × 10⁶ | 4.1 | 1.1 × 10³ |
| Example 39 | | CHCl₂ | CHCl₂ | 1.5 × 10³-3.3 × 10⁶ | 4.0 | 1.1 × 10³ |
| Example 40 | | CCl₃ | H | 1.2 × 10³-3.3 × 10⁶ | 4.2 | 1.2 × 10³ |
| Example 41 | | H | CCl₃ | 1.2 × 10³-3.3 × 10⁶ | 4.2 | 1.2 × 10³ |
| Example 42 | | CCl₃ | CCl₃ | 1.9 × 10³-3.3 × 10⁶ | 4.0 | 1.1 × 10³ |
| Example 43 | | CH₂Br | H | 1.1 × 10³-3.3 × 10⁶ | 4.1 | 1.1 × 10³ |
| Example 44 | | H | CH₂Br | 1.1 × 10³-3.3 × 10⁶ | 4.1 | 1.1 × 10³ |
| Example 45 | | CH₂Br | CH₂Br | 1.6 × 10³-3.3 × 10⁶ | 3.8 | 1.1 × 10³ |
| Example 46 | | CHBr₂ | H | 1.5 × 10 [symbol] -3.3 × 10⁶ | 4.1 | 1.1 × 10³ |
| Example 47 | | H | CHBr₂ | 1.5 × 10³-3.3 × 10⁶ | 4.1 | 1.1 × 10³ |
| Example 48 | | CHBr₂ | CHBr₂ | 2.4 × 10³-3.3 × 10⁶ | 4.0 | 1.1 × 10³ |
| Example 49 | | CBr₃ | H | 1.9 × 10 [symbol] -3.3 × 10⁶ | 4.3 | 1.2 × 10³ |
| Example 50 | | H | CBr₃ | 1.9 × 10³-3.3 × 10⁶ | 4.3 | 1.2 × 10³ |
| Example 51 | | CBr₃ | CBr₃ | 3.2 × 10³-3.3 × 10⁶ | 4.2 | 1.2 × 10³ |
| Example 52 | | CHOHCH₂OH | H | 9.5 × 10²-3.3 × 10⁶ | 5.0 | 1.4 × 10³ |
| Example 53 | | H | CHOHCH₂OH | 9.5 × 10²-3.3 × 10⁶ | 5.0 | 1.4 × 10³ |
| Example 54 | | CHOHCH₂OH | CHOHCH₂OH | 1.3 × 10³-3.3 × 10⁶ | 5.3 | 1.5 × 10³ |

[symbol]

indicates data missing or illegible when filed

TABLE 3

| | | Substituent | | | | Capacitance |
|---|---|---|---|---|---|---|
| | High-Molecular Compound (II) | R₁ | R₂ | Molecular Weight | Dielectric Constant | (μF) |
| Example 55 Example 56 Example 57 Example 58 Example 59 Example 60 Example 61 Example 62 Example 63 | 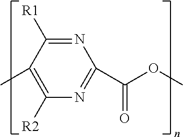 | F F Cl Cl Br Br OH OH CHO | H F H Cl H Br H OH H | 7.3 × 10²-3.3 × 10⁶ 8.2 × 10²-3.7 × 10⁶ 8.1 × 10²-3.7 × 10⁶ 9.9 × 10²-4.5 × 10⁶ 1.0 × 10³-4.7 × 10⁶ 1.5 × 10³-6.6 × 10⁶ 7.2 × 10²-3.2 × 10⁶ 8.9 × 10²-4.0 × 10⁶ 7.8 × 10²-3.5 × 10⁶ | 4.3 4.2 4.5 4.4 4.5 4.5 5.2 5.8 4.8 | 1.2 × 10³ 1.2 × 10³ 1.2 × 10³ 1.2 × 10³ 1.2 × 10³ 1.2 × 10³ 1.4 × 10³ 1.5 × 10³ 1.3 × 10³ |
| Example 64 | | CHO | CHO | 9.3 × 10²-4.2 × 10⁶ | 5.0 | 1.3 × 10³ |
| Example 65 | | COOH | H | 8.6 × 10²-3.9 × 10⁶ | 4.8 | 1.3 × 10³ |
| Example 66 | | COOH | COOH | 1.1 × 10³-4.9 × 10⁶ | 4.9 | 1.4 × 10³ |
| Example 67 | | CH₃ | H | 7.1 × 10²-3.2 × 10⁶ | 4.2 | 1.1 × 10³ |
| Example 68 | | CH₃ | CH₃ | 7.8 × 10²-3.5 × 10⁶ | 3.9 | 1.1 × 10³ |
| Example 69 | | C₂H₅ | H | 7.8 × 10²-3.5 × 10⁶ | 3.9 | 1.1 × 10³ |
| Example 70 | | C₂H₅ | C₂H₅ | 9.3 × 10²-4.2 × 10⁶ | 3.5 | 1.0 × 10³ |
| Example 71 | | CH₂F | H | 8.0 × 10²-3.6 × 10⁶ | 4.1 | 1.1 × 10³ |
| Example 72 | | CH₂F | CH₂F | 9.7 × 10²-4.4 × 10⁶ | 3.8 | 1.1 × 10³ |

TABLE 4

| | | Substituent | | | | Capacitance |
|---|---|---|---|---|---|---|
| | High-Molecular Compound (II) | R₁ | R₂ | Molecular Weight | Dielectric Constant | (μF) |
| Example 73 Example 74 Example 75 Example 76 Example 77 Example 78 Example 79 Example 80 Example 81 | 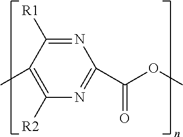 | CHF₂ CHF₂ CF₃ CF₃ CH₂Cl CH₂Cl CHCl₂ CHCl₂ CCl₃ | H CHF₂ H CF₃ H CH₂Cl H CHCl₂ H | 9.0 × 10²-4.0 × 10⁶ 1.2 × 10³-5.2 × 10⁶ 9.9 × 10²-4.5 × 10⁶ 1.3 × 10³-6.0 × 10⁶ 8.9 × 10²-4.0 × 10⁶ 1.1 × 10³-5.1 × 10⁶ 1.1 × 10³-4.8 × 10⁶ 8.9 × 10²-4.0 × 10⁶ 1.2 × 10³-5.6 × 10⁶ | 4.0 3.6 3.8 3.5 4.1 3.9 4.1 4.0 4.2 | 1.1 × 10³ 1.1 × 10³ 1.1 × 10³ 1.0 × 10³ 1.1 × 10³ 1.1 × 10³ 1.1 × 10³ 1.1 × 10³ 1.2 × 10³ |
| Example 82 | | CCl₃ | CCl₃ | 1.9 × 10³-8.4 × 10⁶ | 4.0 | 1.1 × 10³ |
| Example 83 | | CH₂Br | H | 1.1 × 10³-5.0 × 10⁶ | 4.1 | 1.1 × 10³ |
| Example 84 | | CH₂Br | CH₂Br | 1.6 × 10³-7.2 × 10⁶ | 3.8 | 1.1 × 10³ |
| Example 85 | | CHBr₂ | H | 1.5 × 10³-6.9 × 10⁶ | 4.1 | 1.1 × 10³ |
| Example 86 | | CHBr₂ | CHBr₂ | 2.4 × 10³-1.1 × 10⁷ | 4.0 | 1.1 × 10³ |
| Example 87 | | CBr₃ | H | 1.9 × 10³-8.7 × 10⁶ | 4.3 | 1.2 × 10³ |
| Example 88 | | CBr₃ | CBr₃ | 3.2 × 10³-1.5 × 10⁷ | 4.2 | 1.2 × 10³ |
| Example 89 | | CHOHCH₂OH | H | 9.5 × 10²-4.3 × 10⁶ | 5.0 | 1.4 × 10³ |
| Example 90 | | CHOHCH₂OH | CHOHCH₂OH | 1.3 × 10³-5.7 × 10⁶ | 5.3 | 1.5 × 10³ |

TABLE 5

| | | Substituent | | | | Capacitance |
|---|---|---|---|---|---|---|
| | High-Molecular Compound (III) | R₁ | R₂ | Molecular Weight | Dielectric Constant | (μF) |
| Example 91 Example 92 Example 93 Example 94 Example 95 Example 96 Example 97 Example 98 Example 99 | 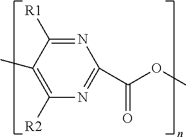 | H F F Cl Cl Br Br OH OH | H H F H Cl H Br H OH | 6.4 × 10²-2.9 × 10⁶ 7.3 × 10²-3.3 × 10⁶ 8.2 × 10²-3.7 × 10⁶ 8.1 × 10²-3.7 × 10⁶ 9.9 × 10²-4.5 × 10⁶ 1.0 × 10³-4.7 × 10⁶ 1.5 × 10³-6.6 × 10⁶ 8.9 × 10²-4.0 × 10⁶ 8.0 × 10²-3.6 × 10⁶ | 4.5 4.3 4.2 4.4 4.4 4.5 4.5 5.2 5.8 | 1.2 × 10³ 1.2 × 10³ 1.2 × 10³ 1.2 × 10³ 1.2 × 10³ 1.2 × 10³ 1.2 × 10³ 1.4 × 10³ 1.6 × 10³ |
| Example 100 | | CHO | H | 7.8 × 10²-3.5 × 10⁶ | 4.8 | 1.3 × 10³ |
| Example 101 | | CHO | CHO | 9.3 × 10²-4.2 × 10⁶ | 5.0 | 1.4 × 10³ |
| Example 102 | | COOH | H | 8.6 × 10²-3.9 × 10⁶ | 4.8 | 1.3 × 10³ |
| Example 103 | | COOH | COOH | 1.1 × 10³-4.9 × 10⁶ | 4.9 | 1.4 × 10³ |
| Example 104 | | CH₃ | H | 7.1 × 10²-3.2 × 10⁶ | 4.2 | 1.2 × 10³ |
| Example 105 | | CH₃ | CH₃ | 7.8 × 10²-3.5 × 10⁶ | 3.9 | 1.1 × 10³ |
| Example 106 | | C₂H₅ | H | 7.8 × 10²-3.5 × 10⁶ | 3.9 | 1.1 × 10³ |
| Example 107 | | C₂H₅ | C₂H₅ | 9.3 × 10²-4.2 × 10⁶ | 3.5 | 1.0 × 10³ |
| Example 108 | | CH₂F | H | 8.0 × 10²-3.6 × 10⁶ | 4.1 | 1.1 × 10³ |
| Example 109 | | CH₂F | CH₂F | 9.7 × 10²-4.4 × 10⁶ | 3.8 | 1.1 × 10³ |

TABLE 6

| | | Substituent | | | | Capacitance |
|---|---|---|---|---|---|---|
| | High-Molecular Compound (III) | R₁ | R₂ | Molecular Weight | Dielectric Constant | (μF) |
| Example 110 Example 111 Example 112 Example 113 Example 114 Example 115 Example 116 Example 117 Example 118 | 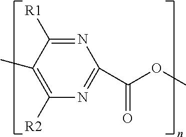 | CHF₂ CHF₂ CF₃ CF₃ CH₂Cl CH₂Cl CHCl₂ CHCl₂ CCl₃ | H CHF₂ H CF₃ H CH₂Cl H CHCl₂ H | 9.0 × 10²-4.0 × 10⁵ 1.2 × 10³-5.2 × 10⁶ 9.9 × 10²-4.5 × 10⁶ 1.3 × 10³-6.0 × 10⁵ 8.9 × 10²-4.0 × 10⁶ 1.1 × 10³-5.1 × 10⁶ 1.1 × 10³-4.8 × 10⁶ 8.9 × 10²-4.0 × 10⁶ 1.2 × 10³-5.6 × 10⁶ | 4.0 3.6 3.8 3.5 4.1 3.9 4.1 4.0 4.2 | 1.1 × 10³ 1.0 × 10³ 1.1 × 10³ 1.0 × 10³ 1.1 × 10³ 1.1 × 10³ 1.1 × 10³ 1.1 × 10³ 1.2 × 10³ |
| Example 119 | | CCl₃ | CCl₃ | 1.9 × 10³-8.4 × 10⁶ | 4.0 | 1.1 × 10³ |
| Example 120 | | CH₂Br | H | 1.1 × 10³-5.0 × 10⁵ | 4.1 | 1.1 × 10³ |
| Example 121 | | CH₂Br | CH₂Br | 1.6 × 10³-7.2 × 10⁶ | 3.8 | 1.1 × 10³ |
| Example 122 | | CHBr₂ | H | 1.5 × 10³-6.9 × 10⁶ | 4.1 | 1.1 × 10³ |
| Example 123 | | CHBr₂ | CHBr₂ | 2.4 × 10³-1.1 × 10⁷ | 4.0 | 1.1 × 10³ |
| Example 124 | | CBr₃ | H | 1.9 × 10³-8.7 × 10⁶ | 4.3 | 1.2 × 10³ |
| Example 125 | | CBr₃ | CBr₃ | 3.2 × 10³-1.5 × 10⁷ | 4.2 | 1.2 × 10³ |
| Example 126 | | CHOHCH₂OH | H | 9.5 × 10²-4.3 × 10⁵ | 5.0 | 1.4 × 10³ |
| Example 127 | | CHOHCH₂OH | CHOHCH₂OH | 1.3 × 10³-5.7 × 10⁶ | 5.3 | 1.5 × 10³ |

TABLE 7

| | | Substituent | | | | Capacitance |
|---|---|---|---|---|---|---|
| | High-Molecular Compound (IV) | R₁ | R₂ | Molecular Weight | Dielectric Constant | (μF) |
| Example 128 Example 129 Example 130 Example 131 Example 132 Example 133 Example 134 Example 135 Example 136 | 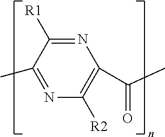 | H F F Cl Cl Br Br OH OH | H H F H Cl H Br H OH | 5.5 × 10²-2.5 × 10⁶ 6.5 × 10²-2.9 × 10⁶ 7.4 × 10²-3.3 × 10⁶ 7.3 × 10²-3.3 × 10⁶ 7.3 × 10²-3.3 × 10⁶ 9.6 × 10²-4.3 × 10⁶ 1.4 × 10³-6.2 × 10⁶ 8.9 × 10²-4.0 × 10⁶ 7.2 × 10²-3.2 × 10⁶ | 4.8 4.6 4.4 4.7 4.6 4.7 4.7 5.5 6.1 | 1.3 × 10³ 1.3 × 10³ 1.2 × 10³ 1.3 × 10³ 1.3 × 10³ 1.3 × 10³ 1.3 × 10³ 1.5 × 10³ 1.7 × 10³ |
| Example 137 | | CHO | H | 7.0 × 10²-3.1 × 10⁶ | 5.0 | 1.4 × 10³ |
| Example 138 | | CHO | CHO | 8.4 × 10²-3.8 × 10⁶ | 5.2 | 1.4 × 10³ |
| Example 139 | | COOH | H | 7.8 × 10²-3.5 × 10⁶ | 5.0 | 1.4 × 10³ |
| Example 140 | | COOH | COOH | 1.0 × 10³-4.5 × 10⁶ | 5.1 | 1.4 × 10³ |
| Example 141 | | CH₃ | H | 6.8 × 10²-2.8 × 10⁶ | 4.4 | 1.2 × 10³ |
| Example 142 | | CH₃ | CH₃ | 7.0 × 10²-3.1 × 10⁶ | 4.1 | 1.1 × 10³ |
| Example 143 | | C₂H₅ | H | 7.0 × 10²-3.1 × 10⁶ | 4.0 | 1.1 × 10³ |
| Example 144 | | C₂H₅ | C₂H₅ | 8.4 × 10²-3.8 × 10⁶ | 3.6 | 1.1 × 10³ |
| Example 145 | | CH₂F | H | 7.2 × 10²-3.2 × 10⁶ | 4.3 | 1.2 × 10³ |
| Example 146 | | CH₂F | CH₂F | 8.9 × 10²-4.0 × 10⁶ | 4.0 | 1.1 × 10³ |

TABLE 8

| | | Substituent | | | | Capacitance |
|---|---|---|---|---|---|---|
| | High-Molecular Compound (IV) | R₁ | R₂ | Molecular Weight | Dielectric Constant | (μF) |
| Example 147 Example 148 Example 149 Example 150 Example 151 Example 152 Example 153 Example 154 Example 155 | 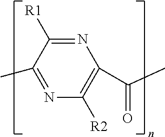 | CHF₂ CHF₂ CF₃ CF₃ CH₂Cl CH₂Cl CHCl₂ CHCl₂ CCl₃ | H CHF₂ H CF₃ H CH₂Cl H CHCl₂ H | 8.1 × 10²-3.7 × 10⁶ 1.1 × 10³-4.8 × 10⁶ 9.1 × 10²-4.6 × 10⁶ 1.3 × 10³-5.7 × 10⁶ 8.0 × 10²-3.6 × 10⁶ 1.1 × 10³-4.8 × 10⁶ 9.8 × 10²-4.4 × 10⁶ 8.9 × 10²-4.0 × 10⁶ 1.2 × 10³-5.2 × 10⁶ | 4.1 3.8 4.0 3.6 4.3 4.0 4.3 4.1 4.3 | 1.1 × 10³ 1.0 × 10³ 1.1 × 10³ 1.0 × 10³ 1.2 × 10³ 1.1 × 10³ 1.2 × 10³ 1.1 × 10³ 1.2 × 10³ |
| Example 156 | | CCl₃ | CCl₃ | 1.8 × 10²-8.0 × 10⁶ | 4.1 | 1.1 × 10³ |
| Example 157 | | CH₂Br | H | 1.0 × 10²-4.7 × 10⁶ | 4.2 | 1.2 × 10³ |
| Example 158 | | CH₂Br | CH₂Br | 1.5 × 10²-6.8 × 10⁶ | 3.9 | 1.1 × 10³ |
| Example 159 | | CHBr₂ | H | 1.4 × 10²-6.5 × 10⁶ | 4.3 | 1.2 × 10³ |
| Example 160 | | CHBr₂ | CHBr₂ | 2.3 × 10²-1.1 × 10⁷ | 4.1 | 1.1 × 10³ |
| Example 161 | | CBr₃ | H | 1.9 × 10²-8.4 × 10⁶ | 4.1 | 1.1 × 10³ |
| Example 162 | | CBr₃ | CBr₃ | 3.2 × 10²-1.4 × 10⁷ | 4.3 | 1.2 × 10³ |
| Example 163 | | CHOHCH₂OH | H | 8.6 × 10²-3.9 × 10⁶ | 5.2 | 1.5 × 10³ |
| Example 164 | | CHOHCH₂OH | CHOHCH₂OH | 1.2 × 10²-5.3 × 10⁶ | 5.5 | 1.5 × 10³ |

TABLE 9

| | | Substituent | | | | Capacitance |
|---|---|---|---|---|---|---|
| | High-Molecular Compound (V) | R₁ | R₂ | Molecular Weight | Dielectric Constant | (μF) |
| Example 165 Example 166 Example 167 Example 168 Example 169 Example 170 Example 171 Example 172 Example 173 | 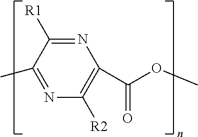 | H F H F Cl H Cl Br H | H H F F H Cl Cl H Br | 6.4 × 10²-2.9 × 10⁶ 7.3 × 10²-3.3 × 10⁶ 7.3 × 10²-3.3 × 10⁶ 8.2 × 10²-3.7 × 10⁶ 8.1 × 10²-3.7 × 10⁶ 8.1 × 10²-3.7 × 10⁶ 9.9 × 10²-4.5 × 10⁶ 8.9 × 10²-4.0 × 10⁶ 1.0 × 10³-4.7 × 10⁶ | 4.5 4.3 4.3 4.2 4.4 4.4 4.4 4.5 4.5 | 1.2 × 10³ 1.2 × 10³ 1.2 × 10³ 1.2 × 10³ 1.2 × 10³ 1.2 × 10³ 1.2 × 10³ 1.2 × 10³ 1.2 × 10³ |
| Example 174 | | Br | Br | 1.5 × 10³-6.6 × 10⁶ | 4.5 | 1.2 × 10³ |
| Example 175 | | OH | H | 7.2 × 10²-3.2 × 10⁶ | 5.2 | 1.4 × 10³ |
| Example 176 | | H | OH | 7.2 × 10²-3.2 × 10⁶ | 5.2 | 1.4 × 10³ |
| Example 177 | | OH | OH | 8.0 × 10²-3.6 × 10⁶ | 5.8 | 1.6 × 10³ |
| Example 178 | | CHO | H | 7.8 × 10²-3.5 × 10⁶ | 4.8 | 1.3 × 10³ |
| Example 179 | | H | CHO | 7.8 × 10²-3.5 × 10⁶ | 4.8 | 1.3 × 10³ |
| Example 180 | | CHO | CHO | 9.3 × 10²-4.2 × 10⁶ | 5.0 | 1.4 × 10³ |
| Example 181 | | COOH | H | 8.6 × 10²-3.9 × 10⁶ | 4.8 | 1.3 × 10³ |
| Example 182 | | H | COOH | 8.6 × 10²-3.9 × 10⁶ | 4.8 | 1.3 × 10³ |
| Example 183 | | COOH | COOH | 1.1 × 10³-4.9 × 10⁶ | 4.9 | 1.4 × 10³ |
| Example 184 | | CH₃ | H | 7.1 × 10²-3.2 × 10⁶ | 4.2 | 1.2 × 10³ |
| Example 185 | | H | CH₃ | 7.1 × 10²-3.2 × 10⁶ | 4.2 | 1.2 × 10³ |
| Example 186 | | CH₃ | CH₃ | 7.8 × 10²-3.5 × 10⁶ | 3.9 | 1.1 × 10³ |
| Example 187 | | C₂H₅ | H | 7.8 × 10²-3.5 × 10⁶ | 3.9 | 1.1 × 10³ |
| Example 188 | | H | C₂H₅ | 7.8 × 10²-3.5 × 10⁶ | 3.9 | 1.1 × 10³ |
| Example 189 | | C₂H₅ | C₂H₅ | 9.3 × 10²-4.2 × 10⁶ | 3.5 | 1.0 × 10³ |
| Example 190 | | CH₂F | H | 8.0 × 10²-3.6 × 10⁶ | 4.1 | 1.1 × 10³ |
| Example 191 | | H | CH₂F | 8.0 × 10²-3.6 × 10⁶ | 4.1 | 1.1 × 10³ |
| Example 192 | | CH₂F | CH₂F | 9.7 × 10²-4.4 × 10⁶ | 3.8 | 1.1 × 10³ |

TABLE 10

| | | Substituent | | | | Capacitance |
|---|---|---|---|---|---|---|
| | High-Molecular Compound (V) | R₁ | R₂ | Molecular Weight | Dielectric Constant | (μF) |
| Example 193 Example 194 Example 195 Example 196 Example 197 Example 198 Example 199 Example 200 Example 201 | 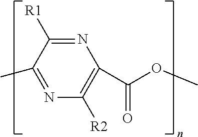 | CHF₂ H CHF₂ CF₃ H CF₃ CH₂Cl H CH₂Cl | H CHF₂ CHF₂ H CF₃ CF₃ H CH₂Cl CH₂Cl | 9.0 × 10²-4.0 × 10⁶ 9.0 × 10²-4.0 × 10⁶ 1.2 × 10³-5.2 × 10⁶ 9.9 × 10²-4.5 × 10⁶ 9.9 × 10²-4.5 × 10⁶ 1.3 × 10³-6.0 × 10⁶ 8.9 × 10²-4.0 × 10⁶ 8.9 × 10²-4.0 × 10⁶ 1.1 × 10³-5.1 × 10⁶ | 4.0 4.0 3.6 3.8 3.8 3.5 4.1 4.1 3.9 | 1.1 × 10³ 1.1 × 10³ 1.0 × 10³ 1.1 × 10³ 1.1 × 10³ 1.0 × 10³ 1.1 × 10³ 1.1 × 10³ 1.1 × 10³ |
| Example 202 | | CHCl₂ | H | 1.1 × 10³-4.8 × 10⁶ | 4.1 | 1.1 × 10³ |
| Example 203 | | H | CHCl₂ | 1.1 × 10³-4.8 × 10⁶ | 4.1 | 1.1 × 10³ |
| Example 204 | | CHCl₂ | CHCl₂ | 1.5 × 10³-6.7 × 10⁶ | 4.0 | 1.1 × 10³ |
| Example 205 | | CCl₃ | H | 1.2 × 10³-5.6 × 10⁶ | 4.2 | 1.2 × 10³ |
| Example 206 | | H | CCl₃ | 1.2 × 10³-5.6 × 10⁶ | 4.2 | 1.2 × 10³ |
| Example 207 | | CCl₃ | CCl₃ | 1.9 × 10³-8.4 × 10⁶ | 4.0 | 1.1 × 10³ |
| Example 208 | | CH₂Br | H | 1.1 × 10³-5.0 × 10⁶ | 4.1 | 1.1 × 10³ |
| Example 209 | | H | CH₂Br | 1.1 × 10³-5.0 × 10⁶ | 4.1 | 1.1 × 10³ |
| Example 210 | | CH₂Br | CH₂Br | 1.6 × 10³-7.2 × 10⁶ | 3.8 | 1.1 × 10³ |
| Example 211 | | CHBr₂ | H | 1.5 × 10³-6.9 × 10⁶ | 4.1 | 1.1 × 10³ |
| Example 212 | | H | CHBr₂ | 1.5 × 10³-6.9 × 10⁶ | 4.1 | 1.1 × 10³ |
| Example 213 | | CHBr₂ | CHBr₂ | 2.4 × 10³-1.1 × 10⁷ | 4.0 | 1.1 × 10³ |
| Example 214 | | CBr₃ | H | 1.9 × 10³-8.7 × 10⁶ | 4.3 | 1.2 × 10³ |
| Example 215 | | H | CBr₃ | 1.9 × 10³-8.7 × 10⁶ | 4.3 | 1.2 × 10³ |
| Example 216 | | CBr₃ | CBr₃ | 3.2 × 10 [symbol] -1.5 × 10⁷ | 4.2 | 1.2 × 10³ |
| Example 217 | | CHOHCH₂OH | H | 9.5 × 10²-4.3 × 10⁶ | 5.0 | 1.4 × 10³ |
| Example 218 | | H | CHOHCH₂OH | 9.5 × 10²-4.3 × 10⁶ | 5.0 | 1.4 × 10³ |
| Example 219 | | CHOHCH₂OH | CHOHCH₂OH | 1.3 × 10³-5.7 × 10⁶ | 5.3 | 1.5 × 10³ |

[symbol]

indicates data missing or illegible when filed

As can be seen form Tables 1 to 10, the present embodiment can provide a novel high-molecular compound with a higher dielectric constant than conventional high-molecular compounds and a capacitor including the high-molecular compound.

### SUMMARY

As can be seen from the embodiment and the examples, a high-molecular compound according to a first aspect of the present disclosure a repeating unit (U) including a diazabenzene ring, a substituent directly bonded to the diazabenzene ring, and a carbonyl group. The substituent includes at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms.

The first aspect provides a novel high-molecular compound with a higher dielectric constant than conventional high-molecular compounds.

In a second aspect of the present disclosure referring to the first aspect, the repeating unit (U) includes a repeating unit (A) expressed by formula (1): where in the formula (1), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

The second aspect enables the dielectric constant of the high-molecular compound to be further increased.

In a third aspect of the present disclosure referring to the first aspect, the repeating unit (U) includes a repeating unit (B) expressed by formula (2): where in the formula (2), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

The third aspect enables the dielectric constant of the high-molecular compound to be further increased.

In a fourth aspect of the present disclosure referring to the first aspect, the repeating unit (U) includes a repeating unit (C) expressed by formula (3): where in the formula (3), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

The fourth aspect enables the dielectric constant of the high-molecular compound to be further increased.

In a fifth aspect of the present disclosure referring to the first aspect, the repeating unit (U) includes a repeating unit (D) expressed by formula (4): where in the formula (4), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

The fifth aspect enables the dielectric constant of the high-molecular compound to be further increased.

In a sixth aspect of the present disclosure referring to the first aspect, the repeating unit (U) includes a repeating unit (E) expressed by formula (5): where in the formula (5), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

The sixth aspect enables the dielectric constant of the high-molecular compound to be further increased.

In a seventh aspect of the present disclosure referring to the second aspect, in the formula (1) of the repeating unit (A), one of R₁ and R₂ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

The seventh aspect enables a high-molecular compound with a further increased dielectric constant to be synthesized by a further simplified method.

In an eighth aspect of the present disclosure referring to the third aspect, in the formula (2) of the repeating unit (B), one of R₁ and R₂ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

The eighth aspect enables a high-molecular compound with a further increased dielectric constant to be synthesized by a further simplified method.

In a ninth aspect of the present disclosure referring to the fourth aspect, in the formula (3) of the repeating unit (C), R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either same as R₁ or H.

The ninth aspect enables a high-molecular compound with a further increased dielectric constant to be synthesized by a further simplified method.

In a tenth aspect of the present disclosure referring to the fifth aspect, in the formula (4) of the repeating unit (D), R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either same as R₁ or H.

The tenth aspect enables a high-molecular compound with a further increased dielectric constant to be synthesized by a further simplified method.

In an eleventh aspect of the present disclosure referring to the sixth aspect, in the formula (5) of the repeating unit (E), one of R₁ and R₂ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

The eleventh aspect enables a high-molecular compound with a further increased dielectric constant to be synthesized by a further simplified method.

A molding composition according to a twelfth aspect includes the high-molecular compound of any one of the first to eleventh aspects.

The twelfth aspect enables a high-molecular compound with a further increased dielectric constant as compared with conventional high-molecular compounds to be synthesized by a further simplified method.

A film according to a thirteenth aspect includes the high-molecular compound of any one of the first to eleventh aspects.

The thirteenth aspect can provide a film having a higher dielectric constant than conventional films.

A capacitor (1) according to a fourteenth aspect includes: a pair of electrodes (11); and a dielectric layer (21) disposed between the pair of electrodes (11). The dielectric layer (21) includes the high-molecular compound of any one of the first to eleventh aspects.

The fourteenth aspect enables the capacitance of the capacitor (1) to be further increased while the thickness of the dielectric layer (21) is maintained. Moreover, while the capacitance of the capacitor (1) is maintained, the size of the capacitor (1) is reduced.

### REFERENCE SIGNS LIST

1 Capacitor
11 Electrode
21 Dielectric Layer
22 Margin Portion
31 Metallized Film
41 Wound Body
51, 52 External Electrode
61, 62 External Connection Terminal

1. A high-molecular compound comprising a repeating unit (U) including a diazabenzene ring, a substituent directly bonded to the diazabenzene ring, and a carbonyl group,
the substituent including at least one selected from the group consisting of a hydrogen atom, a halogen atom, a hydroxy group, a formyl group, a carboxy group, an alkyl group having 1 to 6 carbon atoms, a haloalkyl group having 1 to 6 carbon atoms, and a hydroxy alkyl group having 1 to 6 carbon atoms.

2. The high-molecular compound of claim 1, wherein
the repeating unit (U) includes a repeating unit (A) expressed by the following formula (1): 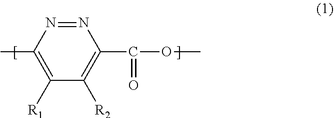
where in the formula (1), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

3. The high-molecular compound of claim 1, wherein
the repeating unit (U) includes a repeating unit (B) expressed by the following formula (2): 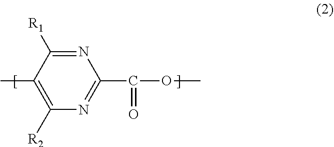
where in the formula (2), R₁ and R₂ are each selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for R₁ or R₂.

4. The high-molecular compound of claim 1, wherein
the repeating unit (U) includes a repeating unit (C) expressed by the following formula (3): 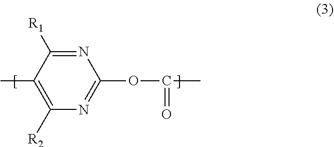
where in the formula (3), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

5. The high-molecular compound of claim 1, wherein
the repeating unit (U) includes a repeating unit (D) expressed by the following formula (4): 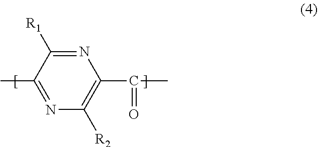
where in the formula (4), R₁ and R₂ are each H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH.

6. The high-molecular compound of claim 1, wherein
the repeating unit (U) includes a repeating unit (E) expressed by the following formula (5): 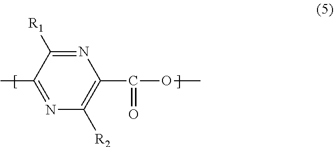
where in the formula (5), R₁ and R₂ are each H, F, Cl, Br, OH, CHO, COOH, CH₃, C₂H₅, CH₂F, CHF₂, CF₃, CH₂Cl, CHCl₂, CCH, CH₂Br, CHBr₂, CBr₃, or CHOHCH₂OH.

7. The high-molecular compound of claim 2, wherein
in the formula (1) of the repeating unit (A), one of R₁ and R₂ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

8. The high-molecular compound of claim 3, wherein
in the formula (2) of the repeating unit (B), one of R₁ and R₂ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

9. The high-molecular compound of claim 4, wherein
in the formula (3) of the repeating unit (C), R₁ is H, F, Cl, Br, OH, CHO, COOH, CH₃, C₂H₅, CH₂F, CHF₂, CF₃, CHCl₂, CHCl₂, CCl₃, CH₂Br, CHBr₂, CBr₃, or CHOHCH₂OH, and R₂ is either same as R₁ or H.

10. The high-molecular compound of claim 5, wherein
in the formula (4) of the repeating unit (D), R₁ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either same as R₁ or H.

11. The high-molecular compound of claim 6, wherein
in the formula (5) of the repeating unit (E), one of R₁ and R₂ is H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and the other of R₁ and R₂ is either same as the one or H.

12. A molding composition comprising the high-molecular compound of claim 1.

13. A film comprising the high-molecular compound of claim 1.

14. A capacitor comprising:
a pair of electrodes; and
a dielectric layer disposed between the pair of electrodes,
the dielectric layer including the high-molecular compound of claim 1.
